(19) United States
(12) Patent Application Publication
(10) Pub. No.: US 2015/0186277 A1
(43) Pub. Date: Jul. 2, 2015

(54) CACHE COHERENT NOC WITH FLEXIBLE NUMBER OF CORES, I/O DEVICES, DIRECTORY STRUCTURE AND COHERENCY POINTS

(71) Applicant: NETSPEED SYSTEMS, San Jose, CA (US)

(72) Inventors: Joe ROWLANDS, San Jose, CA (US); Sailesh KUMAR, San Jose, CA (US)

(73) Assignee: NETSPEED SYSTEMS, San Jose, CA (US)

(21) Appl. No.: 14/144,321

(22) Filed: Dec. 30, 2013

(51) Int. Cl. G06F 12/08

(52) U.S. Cl. CPC G06F 12/0817; G06F 12/0811; G06F 12/0813; G06F 2212/283; G06F 2212/622

(57) ABSTRACT

The present application is directed to designing a NoC interconnect architecture by a means of specification, which can indicate implementation parameters of the NoC including, but not limited to, number of NoC agent interfaces, and number of cache coherency controllers. Flexible identification of NoC agent interfaces and cache coherency controllers allows for an arbitrary number of agents to be associated with the NoC upon configuring the NoC from the specification.

### BACKGROUND

1. Technical Field

Methods and example implementations described herein are generally directed to cache coherent interconnect, and more specifically, to generation of a cache coherent Network on Chip (NoC).

2. Related Art

The number of components on a chip is rapidly growing due to increasing levels of integration, system complexity and shrinking transistor geometry. Complex System-on-Chips (SoCs) may involve a variety of components e.g., processor cores, DSPs, hardware accelerators, memory and I/O, while Chip Multi-Processors (CMPs) may involve a large number of homogenous processor cores, memory and I/O subsystems. In both SoC and CMP systems, the on-chip interconnect plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links.

Messages are injected by the source and are routed from the source node to the destination over multiple intermediate nodes and physical links. The destination node then ejects the message and provides the message to the destination. For the remainder of this application, the terms ‘components’, ‘blocks’, ‘hosts’ or ‘cores’ will be used interchangeably to refer to the various system components which are interconnected using a NoC. Terms ‘routers’ and ‘nodes’ will also be used interchangeably. Without loss of generalization, the system with multiple interconnected components will itself be referred to as a ‘multi-core system’.

There are several topologies in which the routers can connect to one another to create the system network. Bi-directional rings (as shown in FIG. 1(a)), 2-D (two dimensional) mesh (as shown in FIG. 1(b)) and 2-D Torus (as shown in FIG. 1(c)) are examples of topologies in the related art. Mesh and Torus can also be extended to 2.5-D (two and half dimensional) or 3-D (three dimensional) organizations. FIG. 1(d) shows a 3D mesh NoC, where there are three layers of 3×3 2D mesh NoC shown over each other. The NoC routers have up to two additional ports, one connecting to a router in the higher layer, and another connecting to a router in the lower layer. Router 111 in the middle layer of the example has both ports used, one connecting to the router at the top layer and another connecting to the router at the bottom layer. Routers 110 and 112 are at the bottom and top mesh layers respectively, therefore they have only the upper facing port 113 and the lower facing port 114 respectively connected.

Packets are message transport units for intercommunication between various components. Routing involves identifying a path composed of a set of routers and physical links of the network over which packets are sent from a source to a destination. Components are connected to one or multiple ports of one or multiple routers; with each such port having a unique ID. Packets carry the destination's router and port ID for use by the intermediate routers to route the packet to the destination component.

Examples of routing techniques include deterministic routing, which involves choosing the same path from A to B for every packet. This form of routing is independent from the state of the network and does not load balance across path diversities, which might exist in the underlying network. However, such deterministic routing may implemented in hardware, maintains packet ordering and may be rendered free of network level deadlocks. Shortest path routing may minimize the latency as such routing reduces the number of hops from the source to the destination. For this reason, the shortest path may also be the lowest power path for communication between the two components. Dimension-order routing is a form of deterministic shortest path routing in 2-D, 2.5-D, and 3-D mesh networks. In this routing scheme, messages are routed along each coordinates in a particular sequence until the message reaches the final destination. For example in a 3-D mesh network, one may first route along the X dimension until it reaches a router whose X-coordinate is equal to the X-coordinate of the destination router. Next, the message takes a turn and is routed in along Y dimension and finally takes another turn and moves along the Z dimension until the message reaches the final destination router. Dimension ordered routing may be minimal turn and shortest path routing.

FIG. 2(a) pictorially illustrates an example of XY routing in a two dimensional mesh. More specifically, FIG. 2(a) illustrates XY routing from node ‘34’ to node ‘00’. In the example of FIG. 2(a), each component is connected to only one port of one router. A packet is first routed over the x-axis till the packet reaches node ‘04’ where the x-coordinate of the node is the same as the x-coordinate of the destination node. The packet is next routed over the y-axis until the packet reaches the destination node.

In heterogeneous mesh topology in which one or more routers or one or more links are absent, dimension order routing may not be feasible between certain source and destination nodes, and alternative paths may have to be taken. The alternative paths may not be shortest or minimum turn.

Source routing and routing using tables are other routing options used in NoC. Adaptive routing can dynamically change the path taken between two points on the network based on the state of the network. This form of routing may be complex to analyze and implement.

A NoC interconnect may contain multiple physical networks. Over each physical network, there may exist multiple virtual networks, wherein different message types are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects may employ wormhole routing, wherein, a large message or packet is broken into small pieces known as flits (also referred to as flow control digits). The first flit is the header flit, which holds information about this packet's route and key message level info along with payload data and sets up the routing behavior for all subsequent flits associated with the message. Optionally, one or more body flits follows the head flit, containing the remaining payload of data. The final flit is the tail flit, which in addition to containing the last payload also performs some bookkeeping to close the connection for the message. In wormhole flow control, virtual channels are often implemented.

The physical channels are time sliced into a number of independent logical channels called virtual channels (VCs). VCs provide multiple independent paths to route packets, however they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so short that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies, and various channels may have different widths based on the bandwidth requirement at the channel. The bandwidth requirement at a channel is determined by the flows that traverse over the channel and their bandwidth values. Flows traversing over various NoC channels are affected by the routes taken by various flows. In a mesh or Torus NoC, there may exist multiple route paths of equal length or number of hops between any pair of source and destination nodes. For example, in FIG. 2(b), in addition to the standard XY route between nodes 34 and 00, there are additional routes available, such as YX route 203 or a multi-turn route 202 that makes more than one turn from source to destination.

In a NoC with statically allocated routes for various traffic slows, the load at various channels may be controlled by intelligently selecting the routes for various flows. When a large number of traffic flows and substantial path diversity is present, routes can be chosen such that the load on all NoC channels is balanced nearly uniformly, thus avoiding a single point of bottleneck. Once routed, the NoC channel widths can be determined based on the bandwidth demands of flows on the channels. Unfortunately, channel widths cannot be arbitrarily large due to physical hardware design restrictions, such as timing or wiring congestion. There may be a limit on the maximum channel width, thereby putting a limit on the maximum bandwidth of any single NoC channel.

Additionally, wider physical channels may not help in achieving higher bandwidth if messages are short. For example, if a packet is a single flit packet with a 64-bit width, then no matter how wide a channel is, the channel will only be able to carry 64 bits per cycle of data if all packets over the channel are similar. Thus, a channel width is also limited by the message size in the NoC. Due to these limitations on the maximum NoC channel width, a channel may not have enough bandwidth in spite of balancing the routes.

To address the above bandwidth concern, multiple parallel physical NoCs may be used. Each NoC may be called a layer, thus creating a multi-layer NoC architecture. Hosts inject a message on a NoC layer; the message is then routed to the destination on the NoC layer, where it is delivered from the NoC layer to the host. Thus, each layer operates more or less independently from each other, and interactions between layers may only occur during the injection and ejection times. FIG. 3(a) illustrates a two layer NoC. Here the two NoC layers are shown adjacent to each other on the left and right, with the hosts connected to the NoC replicated in both left and right diagrams. A host is connected to two routers in this example—a router in the first layer shown as R1, and a router is the second layer shown as R2. In this example, the multi-layer NoC is different from the 3D NoC, i.e. multiple layers are on a single silicon die and are used to meet the high bandwidth demands of the communication between hosts on the same silicon die. Messages do not go from one layer to another. For purposes of clarity, the present application will utilize such a horizontal left and right illustration for multi-layer NoC to differentiate from the 3D NoCs, which are illustrated by drawing the NoCs vertically over each other.

In FIG. 3(b), a host connected to a router from each layer, R1 and R2 respectively, is illustrated. Each router is connected to other routers in its layer using directional ports 301, and is connected to the host using injection and ejection ports 302. A bridge-logic 303 may sit between the host and the two NoC layers to determine the NoC layer for an outgoing message and sends the message from host to the NoC layer, and also perform the arbitration and multiplexing between incoming messages from the two NoC layers and delivers them to the host.

In a multi-layer NoC, the number of layers needed may depend upon a number of factors such as the aggregate bandwidth requirement of all traffic flows in the system, the routes that are used by various flows, message size distribution, maximum channel width, etc. Once the number of NoC layers in NoC interconnect is determined in a design, different messages and traffic flows may be routed over different NoC layers. Additionally, one may design NoC interconnects such that different layers have different topologies in number of routers, channels and connectivity. The channels in different layers may have different widths based on the flows that traverse over the channel and their bandwidth requirements.

In a NoC interconnect, if the traffic profile is not uniform and there is certain amount of heterogeneity (e.g., certain hosts talk to each other more frequently than the others), the interconnect performance may depend a lot on the NoC topology and where various hosts are placed in the topology with respect to each other and to what routers they are connected to. For example, if two hosts talk to each other frequently and need higher bandwidth, they should be placed next to each other. This will reduce the latency for this communication, and thereby reduce the global average latency, as well as reduce the number of router nodes and links over which the high bandwidth of this communication must be provisioned. Moving two hosts close by may make certain other hosts far apart since all hosts must fit into the 2D planar NoC topology without overlapping with each other. Thus, right tradeoffs must be made and the hosts must be placed after examining the pair-wise bandwidth and latency requirements between all hosts so that certain global cost and performance metrics is optimized. The cost and performance metrics can include the average structural latency between all communicating hosts in number of router hops, or the sum of the bandwidth between all pair of hosts and the distance between them in number of hops, or some combination thereof. This optimization problem is known to be non-deterministic polynomial-time hard (NP-hard) and heuristic based approaches are often used. The hosts in a system may vary is shape and sizes with respect to each other which puts additional complexity in placing them in a 2D planar NoC topology, packing them optimally leaving little whitespaces, and avoiding overlapping hosts.

While generating a NoC, there is a need to maintain cache coherency among agents in the NoC as explained, for example, in U.S. patent application Ser. No. 13/965,668 (Attorney Docket: 120126-NET021), herein incorporated by reference in its entirety for all purposes. Related art methods for maintaining cache coherency involve several methods for maintaining cache coherent data. In one example related art method, a single universal copy of data is maintained and the agents refer only to the universal copy. In another example related art method, agents may include their own cache and thereby maintain their own copies of data. In a heterogeneous system where agents may or may not have their own cache, both of the above mentioned related art methods can be employed and managed by using various cache coherency protocols such as MESI (Modified Exclusive Shared Invalid), MSI, MOESI (Modified Owned Exclusive Shared Invalid) and so on.

To manage transition between states for cache coherency protocols, related art methods perform a lookup of coherent state on cache request. Based on the lookup of the coherent state, transition commands may be issued to existing caches to change their state. The lookup of the coherent state requires either a broadcasting to all of the agents associated with the NoC or a directory structure that tracks the current states and can be used for managing the states of the caches.

Hardware based solutions for maintaining cache coherency have been utilized in related art systems. However, such hardware based solutions are typically constrained to fixed architectures and are designed for a fixed system. For example, in a fixed system having a known number and types of agents and known input/output (I/O) controllers, there may be a specifically designed cache coherency interface NoC for managing the fixed system. However, if different agents are needed (e.g., more or fewer agents, employing different agents that may or may not utilize an internal cache, etc.), the specifically designed cache coherency interface NoC may fail to address the different agents adequately. Therefore, user of a new system will have to wait until another hardware solution (e.g., a next generation cache coherency interface NoC) can be provided. There is therefore a need for a general hardware solution for managing cache coherency within an arbitrary hardware system.

### SUMMARY

The present application is directed to designing an NoC interconnect architecture by a means of specification, which can indicate implementation parameters of the NoC including, but not limited to, number of NoC agent interfaces, and number of cache coherency controllers. Flexible identification of NoC agent interfaces and cache coherency controllers allows for an arbitrary number of agents to be associated with the NoC upon configuring the NoC from the specification.

Aspects of the present application may include a method, which involves configuring one or more NoC agent interfaces based on a NoC specification, and further configuring one or more cache coherency controllers based on the specification of NoC agents. In an additional aspect, cache coherence can be managed by means of a directory, where one or more cache coherency controllers can be associated with a portion of the directory.

Aspect of present application may include a computer readable storage medium storing instructions for executing a process. The instructions may involve processing of a NoC specification for information relating to one or more of agents, hardware elements, bandwidth requirements, latency requirements, among other parameters, and using such processed information to determine one or more hardware elements of the NoC as cache coherency controllers or NoC agent interfaces. The instructions may further involve configuration of the NoC agent interfaces and/or the cache coherency controllers with protocols, bus width, and other parameters as needed based on the specification.

Aspects of present application may include a method, which involves, for a network on chip (NoC) configuration, including a plurality of cores interconnected by a plurality of routers in a heterogeneous or heterogeneous mesh, ring, or torus arrangement, processing of a NoC specification for information relating to one or more of agents, hardware elements, bandwidth requirements, latency requirements, among other parameters, and using such processed information to determine one or more hardware elements of the NoC as cache coherency controllers or NoC agent interfaces. The method may further involve configuration of the NoC agent interfaces and/or the cache coherency controllers with protocols, bus width, and other parameters as needed based on the specification.

Aspects of the present application may include a system, which involves, a NOC specification processing module, a NOC agent interface configuration module, and a cache coherency controller configuration module. NOC specification processing module can be configured to process the NoC specification for retrieving and processing information relating to one or a combination of NoC agents, hardware elements, bandwidth requirements, latency requirements, among other attributes. NOC agent interface configuration module can be configured to determine one or more NoC agent interfaces from a list of hardware elements based on NoC agents and configure the NoC agent interfaces based on one or a combination parameters such as protocols, bus width, among other parameters. Cache coherency controller configuration module, on the other hand, can be configured to determine cache coherency controllers from the list of hardware elements and then configure the determined cache coherency controllers based on one or more parameters including, but not limited to protocols, bus width, and other parameters as needed based on the specification.

### BRIEF DESCRIPTION OF THE DRAWINGS

FIGS. 1(a), 1(b) 1(c) and 1(d) illustrate examples of Bidirectional ring, 2D Mesh, 2D Taurus, and 3D Mesh NoC Topologies.

FIG. 2(a) illustrates an example of XY routing in a related art two dimensional mesh.

FIG. 2(b) illustrates three different routes between a source and destination nodes.

FIG. 3(a) illustrates an example of a related art two layer NoC interconnect.

FIG. 3(b) illustrates the related art bridge logic between host and multiple NoC layers.

FIG. 4 illustrates a configurable NoC in accordance with an example implementation.

FIG. 5 illustrates an example directory divided into portions based on the corresponding cache coherency controller, in accordance with an example implementation.

FIG. 6(a) illustrates an example of a directory containing multiple encodings.

FIG. 6(b) illustrates an example of set associative entries within the directory, in accordance with an example implementation.

FIG. 7 illustrates a flow diagram for generating and configuring a NoC in accordance with an example implementation.

FIG. 8 illustrates a computer/server block diagram upon which the example implementations described herein may be implemented.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

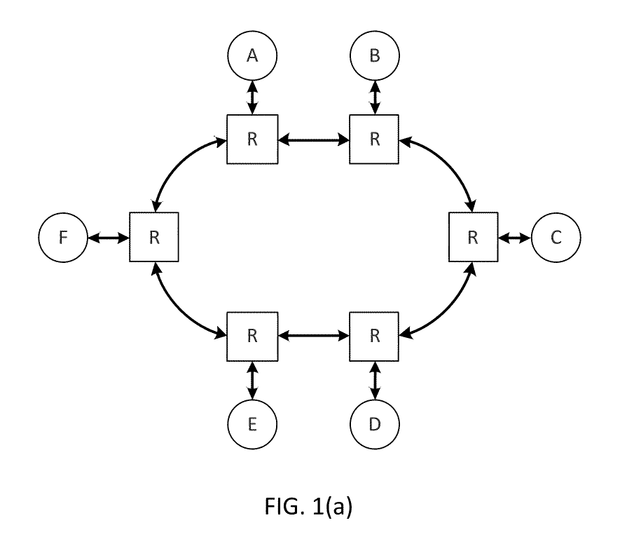

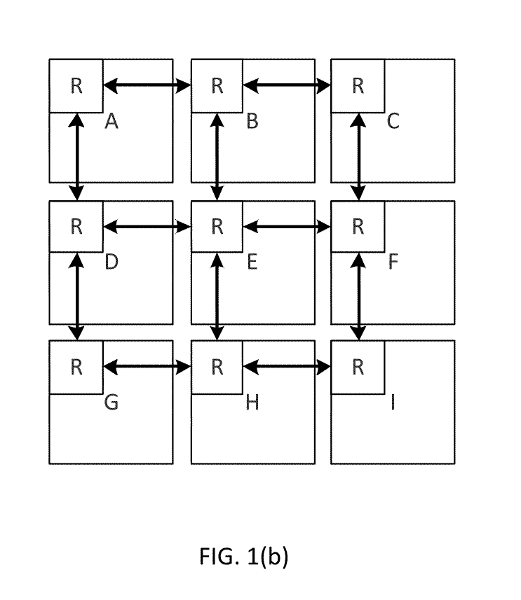

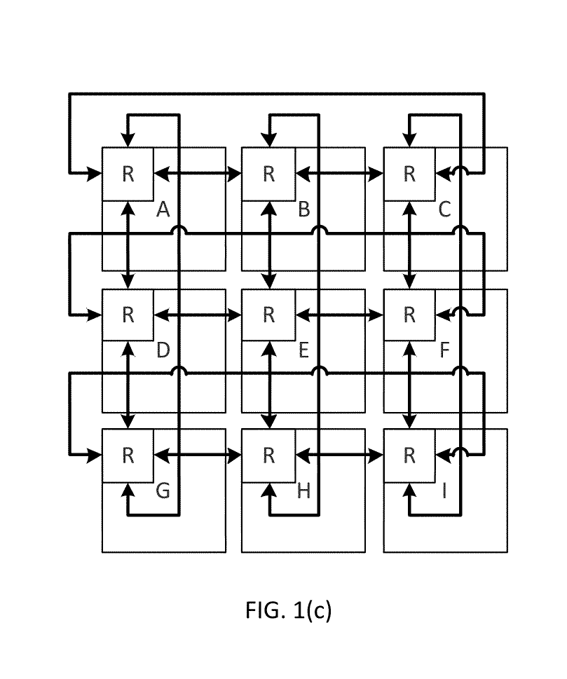

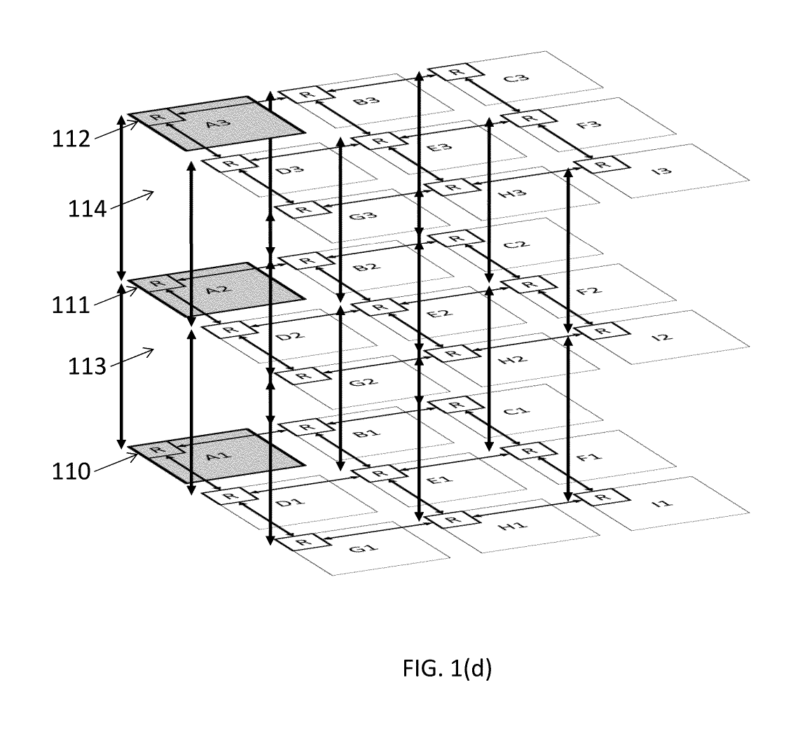

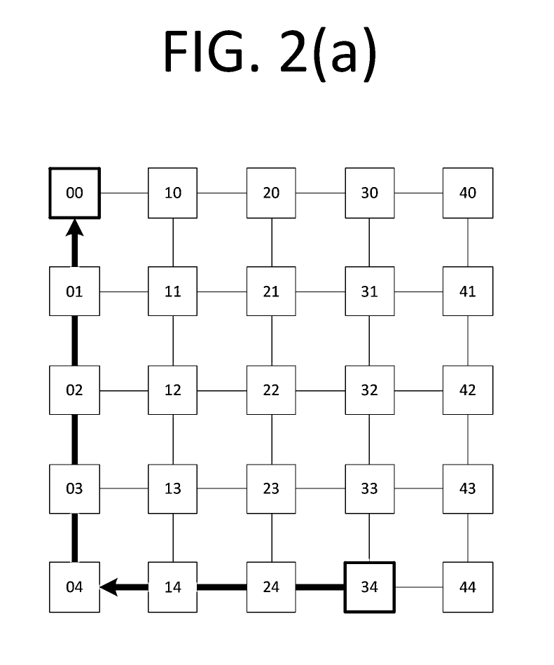

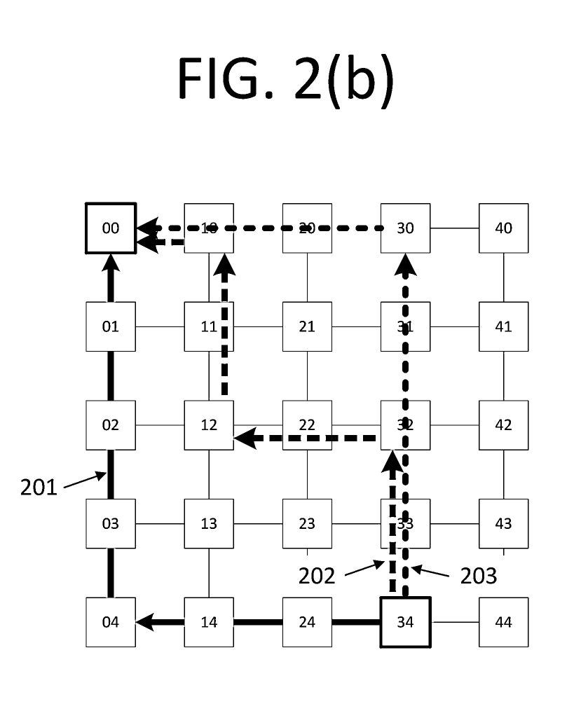

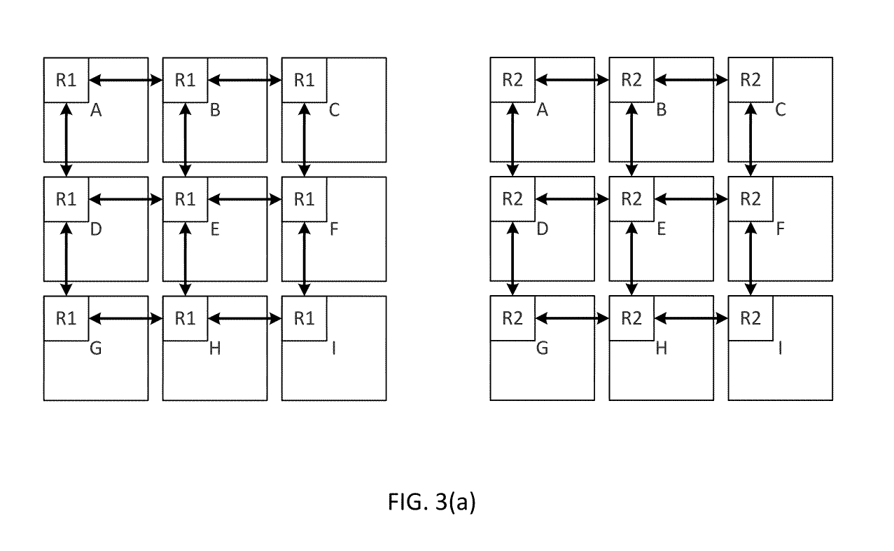

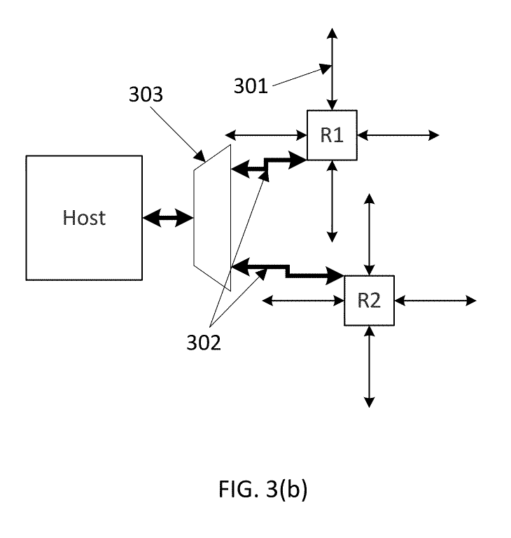

Example implementations described herein are directed to a configurable NoC that includes an arrangement of configurable hardware elements (e.g., hosts) as illustrated, for example, in the topologies of FIGS. 1-3. Proposed NoC interconnect architecture can be configured by a means of a specification, which can indicate implementation parameters of the NoC including, but not limited to, number of NoC agent interfaces, and number of cache coherency controllers. This allows for a flexible or arbitrary number of agents to be associated with the NoC upon configuring the NoC from the specification. In an aspect, NoC of the present disclosure can be configured to include integrated processor (‘IP’) blocks, routers, memory communications controllers, and network interface controller, with each IP block adapted to a router through a memory communications controller and a network interface controller. In another aspect, memory communications controller can further include one or more cache coherency controllers, where each memory communications controller may be configured to control communication between an IP block and memory, and each network interface controller can control inter-IP block communications through routers, wherein the memory communications controller can be configured to execute a memory access instruction and configured to determine state of a cache line addressed by the memory access instruction. Furthermore, state of cache line can be one of shared, exclusive, or invalid.

To facilitate bandwidth and latency requirements, hardware elements can be arranged in an array to provide scalability. One or more of the hardware elements can be configured as cache coherency controllers based on the number of agents in the specification and the bandwidth requirements. Number of cache coherency controllers employed by the NoC can be flexibly determined based on the specification.

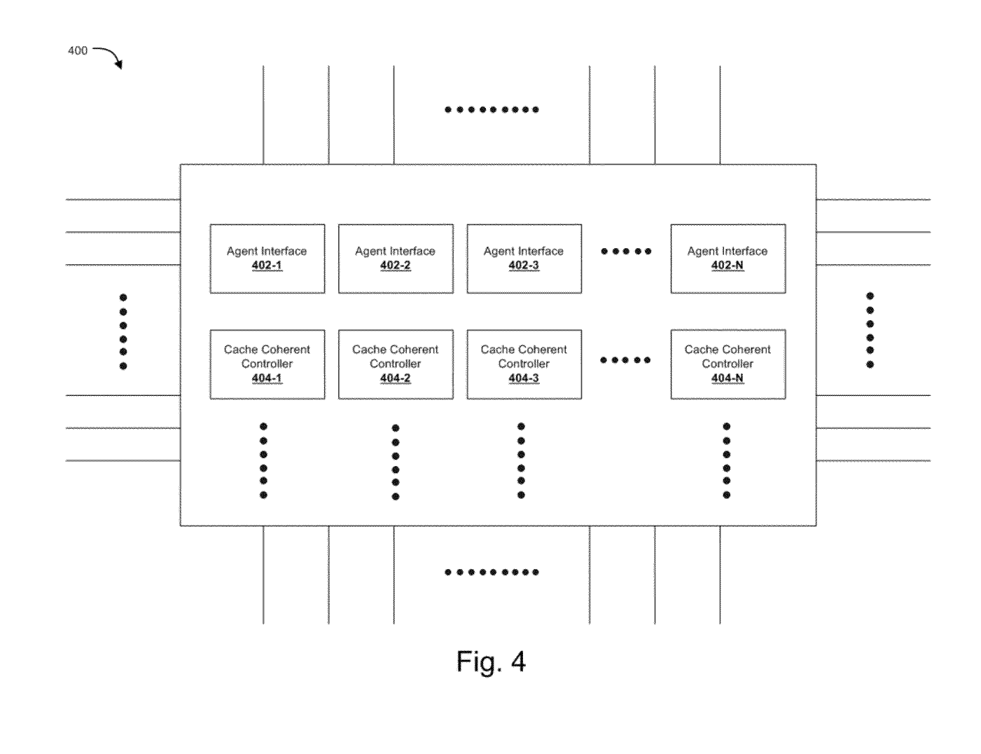

FIG. 4 illustrates a configurable NoC 400 in accordance with an example implementation. In this example implementation, several hardware elements can be configured as NoC agent interfaces 402-1, 402-2, 402-3, . . . 402-n, collectively referred to as agent interfaces 402 hereinafter, and as cache coherency controllers 404-1, 404-2, 404-3, . . . 404-n, collectively referred to as cache coherency controllers 404 hereinafter, based on a specification, and input/output channels from the NoC can be associated with corresponding hardware elements. Configuration of hardware elements as NoC agent interfaces 402 and/or as cache coherency controllers 404 can be based on specification that is used for generating the NoC. As the hardware elements can be configured into either one of the NoC agent interfaces 402 and cache coherency controllers 404, the NoC can thereby be associated with any number and type of agents employed in the hardware system. NoC agent interfaces 402 can be configured to be associated with one or more hardware agents in the system and can be flexibly configurable to facilitate communications with the hardware agents. Cache coherency controllers 404, on the other hand, can be configured to maintain cache coherency between hardware agents and can be flexibly configured to maintain cache coherence for any type and number of agents associated with a respective NoC agent interface.

For hardware elements that are configured into NoC agent interfaces 402, the interface elements 402 need to be capable of facilitating communications to any agent. In an example implementation, one or more NoC agent interfaces can be configured to support multiple protocols such as MESI, MSI, MOESI and so on. Such support can be based on a universal protocol that incorporates all functions of the protocols known to one of skill in the art. Subsets of or modifications to the functions of the universal protocol can also be used for each agent specified in the specification. For example, a NoC agent interface 402 configured with a MOESI based universal protocol can be configured to handle functions of MESI and MSI, and the NoC agent interface 402 can also be configured to utilize subsets of the MOSEI protocol to handle the functions. Configurable NoC agent interfaces 402 can be implemented so as to support different bus widths to facilitate requirements (e.g., bandwidth, latency, etc.) of the corresponding agents from the specification.

In one aspect, hardware elements of NoC can be further configurable into cache coherency controllers 404 based on the number and types of agents utilized and, if needed, further based on the desired implementation. NoC can therefore include one or more cache coherency controllers 404 to manage directory and control logic for the associated agents. Number of cache coherency controllers 404 utilized and their configuration can be based on the number of agents in the specification, and can also be based on coherent bandwidth, latency and throughput requirements.

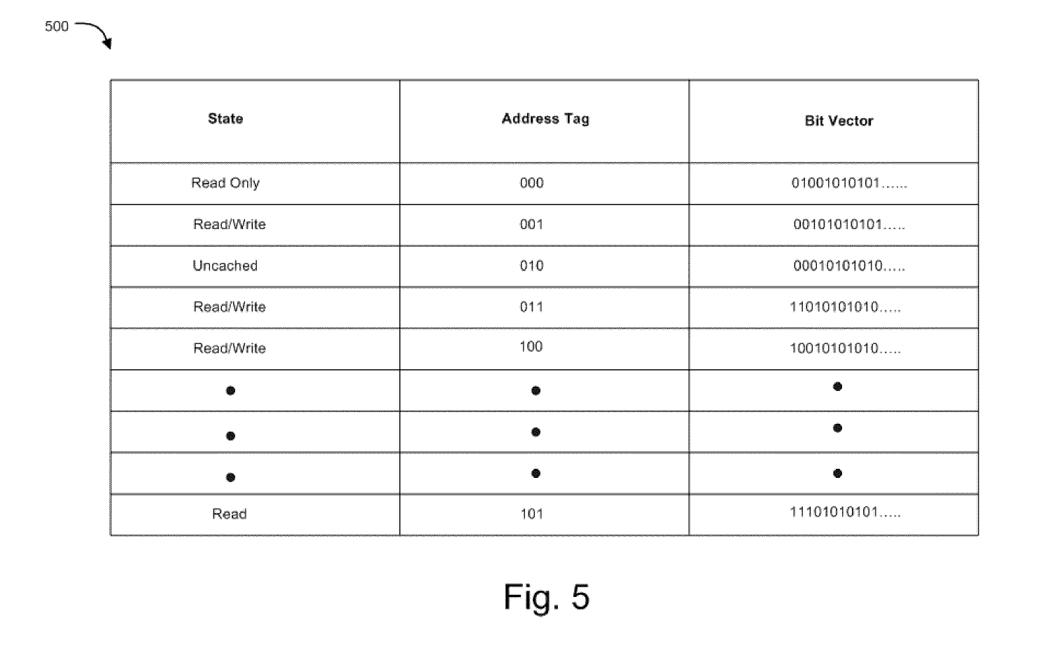

Existing common directories are utilized to manage cache, which can cause latency issues as the number of lookups to the common directory increases. Thus, in example implementations of the present application, each hardware element that is utilized as a cache coherency controller 404 can be further configured to manage a portion of the directory through address slicing. Directory can be configured to manage cache coherence of the NoC agents, where each of the one or more cache coherency controllers can be associated with a portion of the directory. Such directories can be broadcast-based directories and can, in one aspect, follow, protocols such as Hammer protocol. FIG. 5 illustrates an example directory 500 divided into portions based on corresponding cache coherency controller, in accordance with an example implementation. The directory 500 may include entries for state (e.g. read only, read/write, etc.), address tag to indicate address within the cache containing the data, and a bit vector indicating agents that have caches containing the data. In one aspect, bit vector can be flexibly configurable based on the specification. For example, if the NoC is associated with 64 agents, bit vector may have a 64 bit long vector with each bit indicating if the data is held in the corresponding agent or not. In an example involving address splicing, one cache coherency controller of the NoC may be configured to manage address block ‘000’, another may be configured to manage address blocks ‘001’, ‘010’, and ‘011’ another may be assigned to manage address blocks ‘100’ and ‘101’, and so on. Address slicing of the directory to cache coherence controllers therefore provides flexibility in scaling the NoC to meet any number of agents. In one aspect, cache coherency controller can be configured to retrieve, from a directory, state of cache line and return state of the cache line to a requesting memory communications controller. In another aspect, directory 500 can include, for each cache line, a cache line index and a cache line tag identifying the cache line.

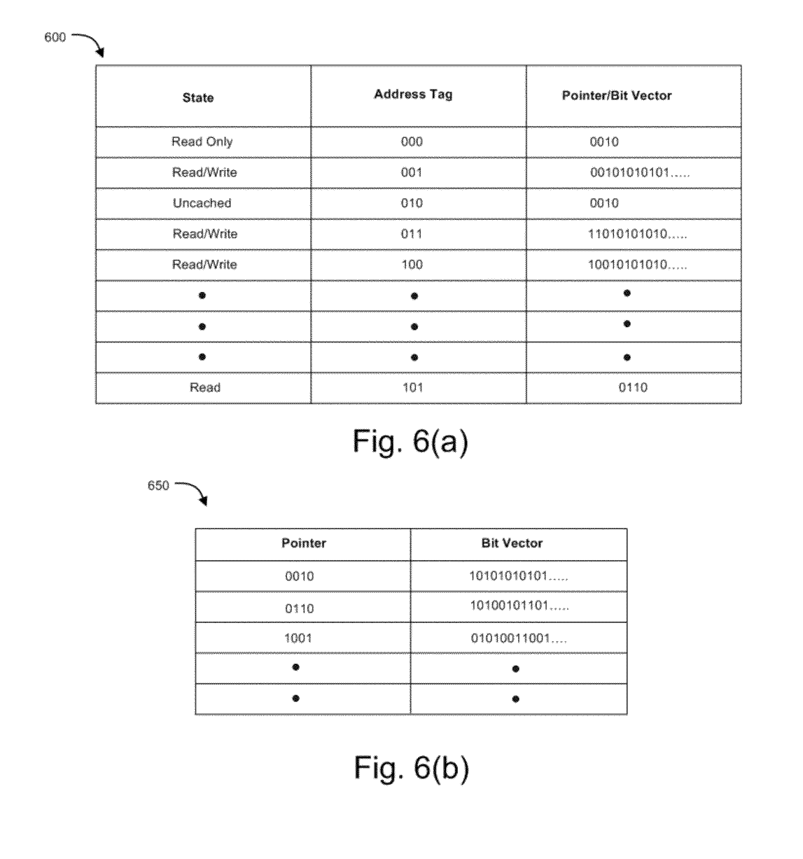

In another example implementation, directory 500 may be scaled in two or more dimensions, and multiple encodings may be used in the directory during implementation. For example, directory 500 can include entries for a first format including the bit vector or a second format including a pointer to a corresponding entry. FIG. 6(a) illustrates an example of a directory containing multiple encodings. In cases where bit vectors can be consolidated, a pointer can be used instead of bit vectors, for instance when the bit vectors are duplicated. Implementing multiple encodings into the directory can reduce the area of directory, thereby allowing better scalability as the number of agents associated with the NoC increases. Pointers can point to consolidated bit vector entries as illustrated in table 650 of FIG. 6(b), which associates addresses and bit vectors in a set associative manner. Index referenced by the pointer can thereby refer to the corresponding address within the directory to find the associated address. Once the address is found, the directory can be traversed across adjacent entries until the bit vector is reached. This implementation thereby allows for an arbitrary two-dimensional directory with a mix of encodings and dimensions. Directory size and shape can therefore be arbitrarily adjusted to accommodate set associativity.

In example implementations involving set association of the directory, further organization can be done by means of a cuckoo hash. For example, entries as illustrated in FIG. 6(b) can be split off into a separate hash table with a different indexing mechanism, wherein the pointer of FIG. 6(a) can refer to the hash index. Cuckoo hashing can be employed to resolve conflicts by popping and re-queuing entries into the hash table.

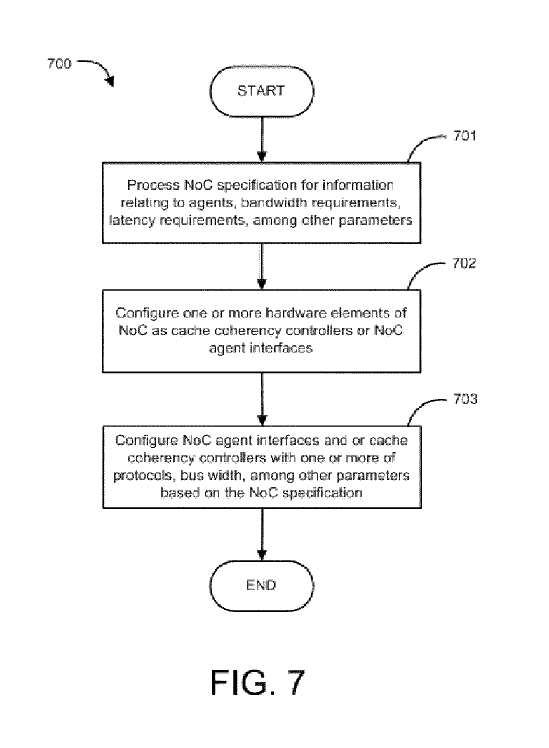

FIG. 7 illustrates a flow diagram 700 for generating and configuring a NoC in accordance with an example implementation. The flow begins at 701 when a specification is processed for information regarding agents, bandwidth requirements, latency requirements, and so on. At 702, a NoC topology is determined and one or more hardware elements of the NoC are configured as cache coherency controllers or NoC agent interfaces. At 703, NoC agent interfaces and/or the cache coherency controllers are configured with protocols, bus width, and other parameters as needed based on the specification. Step 703 can further include configuration of cache coherency controllers based on specification of NoC agents.

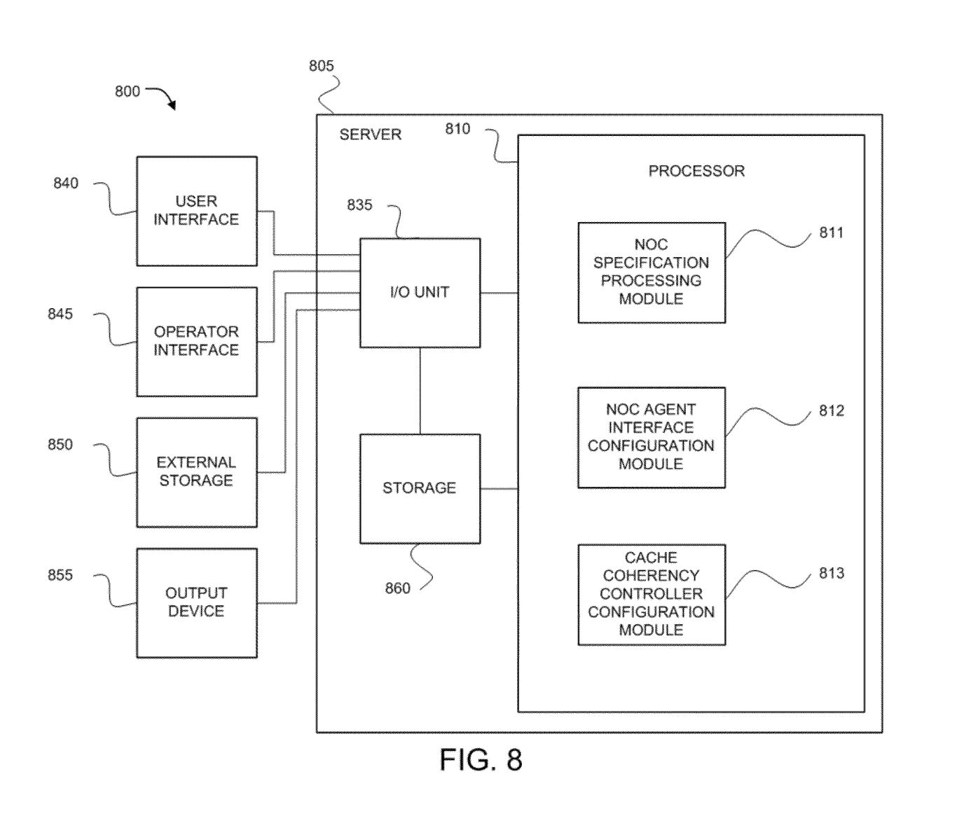

FIG. 8 illustrates an example computer system 800 on which example implementations may be implemented. The computer system 800 includes a server 805 which may involve an I/O unit 835, storage 860, and a processor 810 operable to execute one or more units as known to one of skill in the art. The term “computer-readable medium” as used herein refers to any medium that participates in providing instructions to processor 810 for execution, which may come in the form of computer readable storage mediums, such as, but not limited to optical disks, magnetic disks, read-only memories, random access memories, solid state devices and drives, or any other types of tangible media suitable for storing electronic information, or computer readable signal mediums, which can include media such as carrier waves. The I/O unit processes input from user interfaces 840 and operator interfaces 845 which may utilize input devices such as a keyboard, mouse, touch device, or verbal command.

The server 805 may also be connected to an external storage 850, which can contain removable storage such as a portable hard drive, optical media (CD or DVD), disk media or any other medium from which a computer can read executable code. The server may also be connected an output device 855, such as a display to output data and other information to a user, as well as request additional information from a user. The connections from the server 805 to the user interface 840, the operator interface 845, the external storage 850, and the output device 855 may via wireless protocols, such as the 802.11 standards, Bluetooth® or cellular protocols, or via physical transmission media, such as cables or fiber optics. The output device 855 may therefore further act as an input device for interacting with a user.

The processor 810 may execute one or more modules. System 800 can include a NOC specification processing module 811, a NOC agent interface configuration module 812, and a cache coherency controller configuration module 813. NOC specification processing module 811 can be configured to process the NoC specification for retrieving and processing information relating to one or a combination of NoC agents, hardware elements, bandwidth requirements, latency requirements, among other attributes. NOC agent interface configuration module 812 can be configured to determine one or more NoC agent interfaces from a list of hardware elements based on NoC agents and configure the NoC agent interfaces based on one or a combination parameters such as protocols, bus width, among other parameters.

Cache coherency controller configuration module 813 can be configured to determine cache coherency controllers from the list of hardware elements and then configure the determined cache coherency controllers based on one or more parameters including, but not limited to protocols, bus width, and other parameters as needed based on the specification. In one aspect, protocols that the cache coherency controllers and NoC agent interfaces can be compliant to include MESI (Modified Exclusive Shared Invalid), MSI, MOESI (Modified Owned Exclusive Shared Invalid), among other like protocols. Module 813 can further be configured to include and process a directory that manages cache coherence of the NoC agents, where each of the one or more cache coherency controllers is associated with a portion of the directory.

In some example implementations, the computer system 800 can be implemented in a computing environment such as a cloud. Such a computing environment can include the computer system 800 being implemented as or communicatively connected to one or more other devices by a network and also connected to one or more storage devices. Such devices can include movable user equipment (UE) (e.g., smartphones, devices in vehicles and other machines, devices carried by humans and animals, and the like), mobile devices (e.g., tablets, notebooks, laptops, personal computers, portable televisions, radios, and the like), and devices designed for stationary use (e.g., desktop computers, other computers, information kiosks, televisions with one or more processors embedded therein and/or coupled thereto, radios, and the like).

These algorithmic descriptions and symbolic representations are the means used by those skilled in the data processing arts to most effectively convey the essence of their innovations to others skilled in the art. An algorithm is a series of defined operations leading to a desired end state or result. In the example implementations, the operations carried out require physical manipulations of tangible quantities for achieving a tangible result.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

What is claimed is:

1. A configurable Network on Chip (NoC), comprising:
one or more system agent interfaces configured based on a specification;
one or more cache coherency controllers configured based on the specification of system agents.

2. The configurable NoC of claim 1, further comprising a directory configured to manage cache coherence of the system agents; wherein each of the one or more cache coherency controllers is associated with a portion of the directory.

3. The configurable NoC of claim 2, wherein the directory comprises a plurality of addresses, each address corresponding to an address in one or more caches of the system agents that have a private cache, and wherein the directory further comprises bit vectors indicative of availability of the address at each of the system agent's private caches.

4. The configurable NoC of claim 3, further comprising a hash table configured to manage the directory by cuckoo hashing.

5. The configurable NoC of claim 1, wherein the one or more system agent interfaces are configured to support multiple protocols, and wherein each of the one or more system agent interfaces is configured to support at least one of the multiple protocols based on the specification.

6. The configurable NoC of claim 1, wherein the one or more cache coherency controllers are configured to utilize a flexible protocol and wherein each of the one or more cache coherency controllers are configured to utilize subsets of the flexible protocol to facilitate communication to at least one protocol associated with a respective one of the one or more system agent interfaces.

7. The configurable NoC of claim 1, wherein the one or more system agent interfaces are configured to support different bus widths, wherein a width of each bus of the one or more system agent interfaces is configured based on the specification.

8. A method for a configurable Network on Chip (NoC), comprising:
configuring one or more NoC agent interfaces based on a specification;
configuring one or more cache coherency controllers based on the specification of NoC agents.

9. The method of claim 8, further comprising managing cache coherence of the NoC agents with a directory; wherein each of the one or more cache coherency controllers is associated with a portion of the directory.

10. The method of claim 9, wherein the directory comprises a plurality of addresses, each address corresponding to an entry in one or more caches of the NoC agents that have a cache, and wherein the directory further comprises bit vectors indicative of availability of cache at each of the caches.

11. The method of claim 10, further comprising managing the directory by cuckoo hashing with a hash table.

12. The method of claim 8, further comprising configuring the one or more NoC agent interfaces to support multiple protocols, and configuring the one or more NoC agent interfaces to support at least one of the multiple protocols based on the specification.

13. The method of claim 8, further comprising configuring the one or more cache coherency controllers to utilize a flexible protocol and configuring each of the one or more cache coherency controllers to utilize subsets of the flexible protocol to facilitate communication to at least one protocol associated with a respective one of the one or more NoC agent interfaces.

14. The method of claim 8, further comprising configuring the one or more NoC agent interfaces to support different bus widths, wherein a width of each bus of the one or more NoC agent interfaces is configured based on the specification.
